(19) United States
(12) Patent Application Publication
(10) Pub. No.: US 2021/0086175 A1
(43) Pub. Date: Mar. 25, 2021

(54) OBSERVATION DEVICE AND THE OBSERVATION CARRIER THEREOF

(71) Applicant: Industrial Technology Research Institute, Hsinchu (TW)

(72) Inventors: Sheng-Li Chang, Hsinchu County (TW); Kuang-Vu Chen, Taipei City (TW); Chih-Cheng Hsu, Miaoli County (TW)

(73) Assignee: Industrial Technology Research Institute, Hsinchu (TW)

(21) Appl. No.: 16/724,406

(22) Filed: Dec. 23, 2019

(30) Foreign Application Priority Data
Sep. 25, 2019 (TW) 108134560

(51) Int. Cl. B01L 3/00

(52) U.S. Cl. CPC B01L 3/508; B01L 2300/06; B01L 2300/12; B01L 2300/0832

(57) ABSTRACT

An observation carrier adapted to observe at least one sample is provided. The observation carrier includes a first substrate and a second substrate. The second substrate is stacked on the first substrate. At least one arc-shaped observation flow channel, at least one air drainage channel and at least one air drainage outlet are formed between the first substrate and the second substrate, and the arc-shaped observation flow channel and the air drainage outlet are separated by the air drainage channel. In addition, an observation device having the observation carrier is also provided.

### CROSS-REFERENCE TO RELATED APPLICATION

This application claims the priority benefit of Taiwan application serial no. 108134560, filed on Sep. 25, 2019. The entirety of the above-mentioned patent application is hereby incorporated by reference herein.

### TECHNICAL FIELD

The present disclosure relates to an observation carrier and an observation device, and is particularly related to an observation carrier and an observation device having an observation flow channel.

### BACKGROUND

Cell culture is widely used in cancer research, gene therapy, toxicity testing, tissue engineering, drug development, biopharmaceuticals, vaccine manufacturing, and other fields. In recent years, emerging technologies such as stem cell therapy and tumor cell immunotherapy have also gradually developed. Hence, the demand for cell culture and detection devices in the pharmaceutical industry will increase. After a large number of cells have been cultured, how to confirm the cell number, the survival rate, and the ratio of the number of cells with proper function depends on the techniques of cell observation and counting. Therefore, how to efficiently and accurately observe and count cell samples is an important research topic in this field.

### SUMMARY

The present disclosure provides an observation carrier and an observation device capable of improving the efficiency and accuracy of observing and counting samples.

The present disclosure provides an observation carrier and an observation device adapted to observe at least one sample. The observation carrier comprises a first substrate and a second substrate. The second substrate is stacked on the first substrate. At least one arc-shaped observation flow channel, at least one air drainage channel, and at least one air drainage outlet are formed between the first substrate and the second substrate. The air drainage channel separates the at least one arc-shaped observation flow channel and the air drainage outlet.

The present disclosure provides an observation device adapted to observe at least one sample. The observation device comprises an observation carrier, a light source, a microscopic observation module and a driving unit. The observation carrier comprises a first substrate and a second substrate. The second substrate is stacked on the first substrate. At least one arc-shaped observation flow channel, at least one air drainage channel, and at least one air drainage outlet are formed between the first substrate and the second substrate. The air drainage channel separates the arc-shaped observation flow channel and the air drainage outlet. The light source is disposed on one side of the observation carrier and is adapted to provide a light beam toward the observation carrier. The microscopic observation module is disposed on the other side of the observation carrier and is adapted to observe an image of the at least one sample in the at least one arc-shaped observation flow channel by the light beam. The driving unit is adapted to drive the observation carrier to rotate, such that a plurality of observation positions of the at least one arc-shaped observation flow channel sequentially pass through a transmission path of the light beam.

The foregoing will become better understood from a careful reading of a detailed description provided herein below with appropriate reference to the accompanying drawings.

### BRIEF DESCRIPTION OF THE DRAWINGS

FIG. 1 is a perspective view illustrating an observation carrier according to one embodiment of the present disclosure;

FIG. 2 is an exploded view of the observation carrier shown in FIG. 1;

FIG. 3 illustrates the observation carrier of FIG. 1 for use in an observation device;

FIG. 4A is a partial cross-sectional perspective view of the observation carrier shown in FIG. 1;

FIG. 4B is a partial cross-sectional plan view of the observation carrier shown in FIG. 4A;

FIG. 5 is a perspective view of the driving unit shown in FIG. 3;

FIG. 6 illustrates a plurality of observation positions of the observation carrier shown in FIG. 1;

FIG. 7 is a perspective view of the second substrate according to another embodiment of the present disclosure;

FIG. 8 is a perspective view of the second substrate according to yet another embodiment of the present disclosure; and

FIG. 9 is a perspective view of the second substrate according to yet another embodiment of the present disclosure.

### DETAILED DESCRIPTION OF DISCLOSED EMBODIMENTS

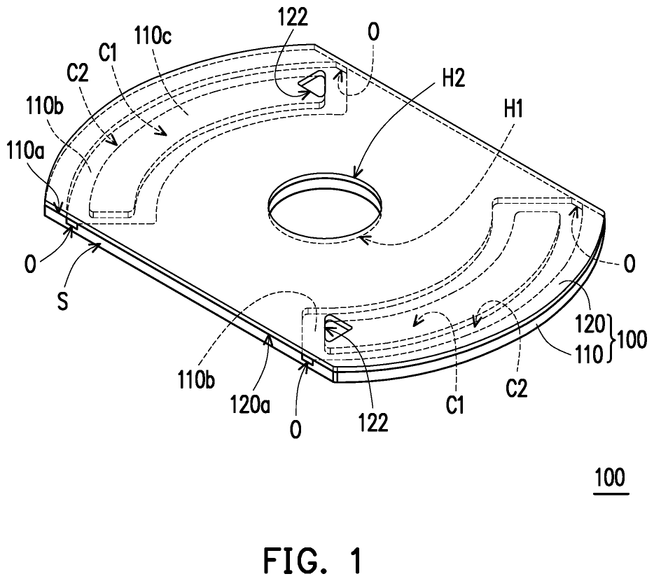

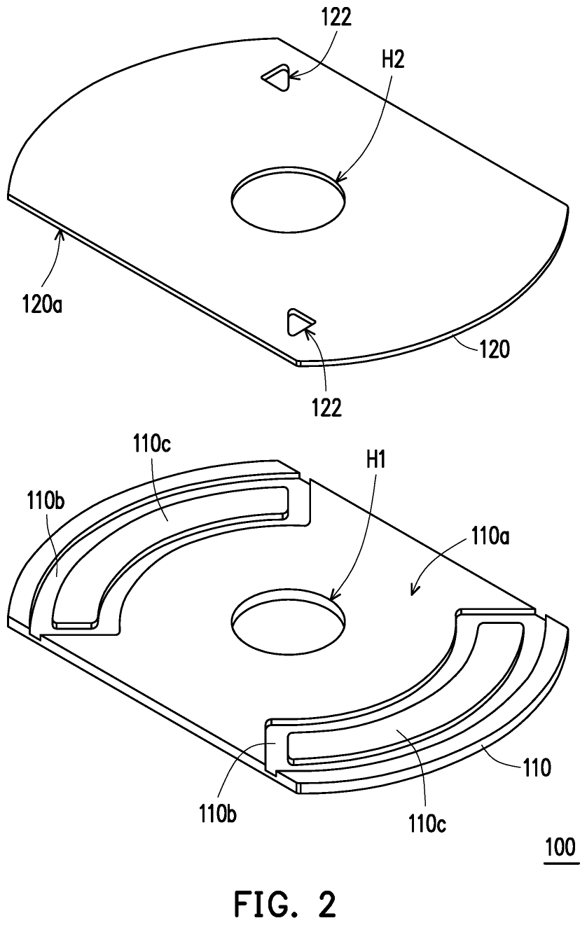

FIG. 1 is a perspective view illustrating an observation carrier 100 of one embodiment of the present disclosure. FIG. 2 is an exploded view of the observation carrier shown in FIG. 1. Referring to FIG. 1 and FIG. 2, in the present embodiment, the observation carrier 100 is adapted to observe at least one sample and comprises a first substrate 110 and a second substrate 120, wherein the first substrate 110 and the second substrate 120 are transparent substrates, such as glass, plastic or other suitable transparent materials. The first substrate 110 comprises a first overlapping surface 110a, the second substrate 120 comprises a second overlapping surface 120a, the second substrate 120 is stacked on the first substrate 110, and the first overlapping surface 110a and the second overlapping surface 120a face each other. In the present embodiment, the first substrate 110 and the second substrate 120 are combined, for example, by ultrasonic welding, gluing, etc., but the scope of the present disclosure is not limited thereto.

At least one arc-shaped observation flow channel C1 (for example, shown as two C1s, respectively), at least one air drainage channel C2 (for example, shown as two C2s, respectively), and at least one air drainage outlet O (for example, shown as four Os, respectively) are formed between the first overlapping surface 110a of the first substrate 110 and the second overlapping surface 120a of the second substrate 120. The second substrate 120 comprises at least one inlet 122 (for example, shown as two 122s, respectively), and the at least one inlet 122 is connected with the at least one arc-shaped observation flow channel C1. At least one sample (such as cell fluid) can be injected into the at least one arc-shaped observation flow channel C1 through the at least one inlet 122. The at least one arc-shaped observation flow channel C1 is used to accommodate at least one sample (such as cells) to be observed. When the at least one sample is injected into the at least one arc-shaped observation flow channel C1, the air in the at least one arc-shaped observation flow channel C1 moves to the at least one air drainage channel C2, and the air in the at least one air drainage channel C2 is discharged through the at least one air drainage outlet O, respectively.

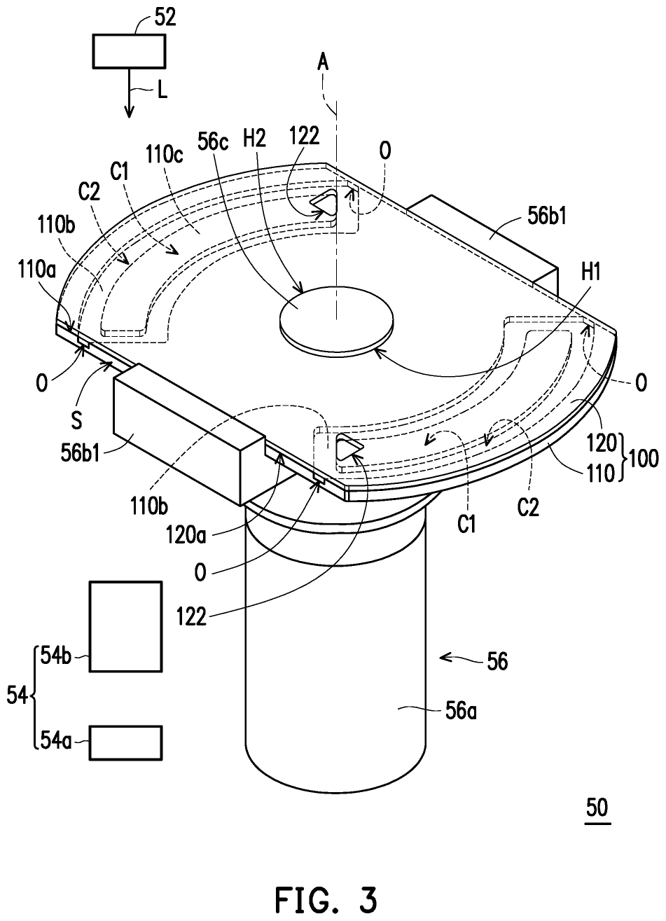

FIG. 3 illustrates the observation carrier of FIG. 1 for use in an observation device. Referring to FIG. 3, the observation device 50 of the present embodiment is adapted to observe at least one sample, and includes the observation carrier 100, a light source 52, a microscopic observation module 54 and a driving unit 56. The light source 52 is disposed on one side of the observation carrier 100 and is adapted to provide a light beam L toward the observation carrier 100. The microscopic observation module 54 is disposed on the other side of the observation carrier 100 and is adapted to observe an image of the at least one sample in the at least one arc-shaped observation flow channel C1 of the observation carrier 100 by the light beam L. The driving unit 56 is adapted to drive the observation carrier 100 to rotate along an axis A, such that a plurality of observation positions of the at least one arc-shaped observation flow channel C1 sequentially pass through a transmission path of the light beam L.

Under the aforesaid configuration of the observation device 50, since the at least one observation flow channel C1 is designed to be arc-shaped, the observation device 50 may drive the observation carrier 100 to rotate and let the plurality of observation positions of the arc-shaped observation flow channel C1 sequentially pass through the observation field of the microscopic observation module 54, which may effectively increase the observation range to improve the counting accuracy of the observations (such as cells). Moreover, as described above, since the observation device 50 only needs to drive the observation carrier 100 to rotate to achieve the effect of increasing the observation range, it is only necessary to configure one single driving unit 56 to drive the observation carrier 100 to rotate without using an X-Y axis mobile platform to drive the observation carrier 100, thereby saving the equipment costs.

Further, as shown in the embodiment of the observation carrier 100 in FIG. 1, the side surface S of the observation carrier 100 is located at the edge of the first overlapping surface 110a and the second overlapping surface 120a. The at least one air drainage channel C2 extends to the side surface S of the observation carrier 100 to form the air drainage outlet O on the side surface S. Each of the at least one air drainage channel C2 surrounds a corresponding arc-shaped observation flow channel C1 to separate the arc-shaped observation flow channel C1 and the air drainage outlet O. In this way, it is effective to prevent the at least one sample to be observed from being unexpectedly moved from the arc-shaped observation flow channel C1 to the air drainage outlet O due to the capillary phenomenon, and causing that the at least one sample cannot be observed successfully.

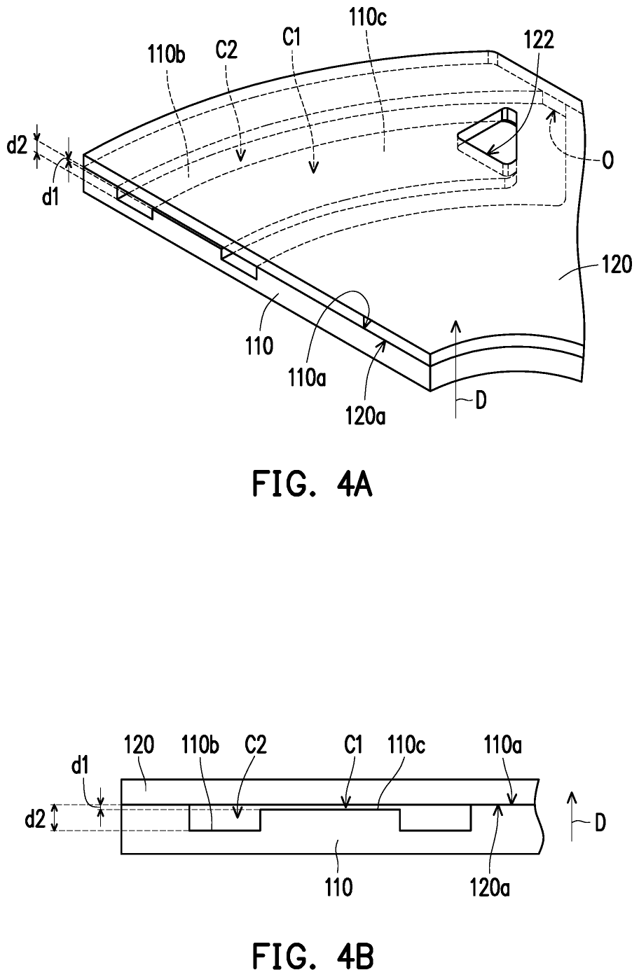

Referring to FIG. 1 and FIG. 2 again, in an embodiment, the first substrate comprises at least one groove 110b (for example, shown as two 110bs, respectively) and at least one arc-shaped platform 110c (for example, shown as two 110cs, respectively) surrounded by the grooves 110b. The arc-shaped observation flow channel C1 is formed between the second substrate 120 and the arc-shaped platform 110c, and the air drainage channel C2 is formed between the second substrate 120 and the groove 110b. FIG. 4A is a partial cross-sectional perspective view of the observation carrier shown in FIG. 1. FIG. 4B is a partial cross-sectional plan view of the observation carrier shown in FIG. 4A. Referring to FIG. 4A and FIG. 4B, further, in the direction D perpendicular to both of the first overlapping surface 110a and the second overlapping surface 120a, the depth d1 of each arc-shaped observation flow channel C1 is less than the depth d2 of each air drainage channel C2. For example, the depth d1 of the arc-shaped observation flow channel C1 is 50 to 120 μm, and is adapted to generate a capillary phenomenon therebetween to distribute the cell fluid in the arc-shaped observation flow channel C1 as uniformly as possible, and the depth d2 of the air drainage channel C2 is, for example, 150 μm or greater than 150 μm, and is adapted to efficiently discharge air to the air drainage outlet O.

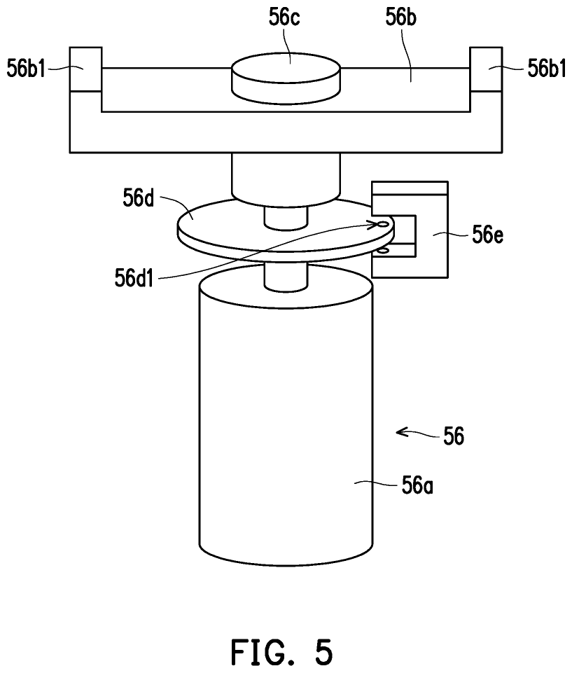

The manner in which the driving unit 56 of the present disclosure drives the observation carrier 100 is described in detail below. FIG. 5 is a perspective view of the driving unit shown in FIG. 3. The driving unit 56 in an embodiment includes a motor 56a, a bearing component 56b and a positioning shaft 56c, as shown in FIG. 3 and FIG. 5. The positioning shaft 56c is connected to the motor 56a. The first substrate 110 and the second substrate 120 comprise the shaft hole H1 and H2 respectively as shown in FIG. 2, and the shaft holes H1 and H2 are located at the curvature center of the arc-shaped observation flow channel C1 and are used to be set on the positioning shaft 56c of the driving unit 56. The bearing component 56b is connected to the positioning shaft 56c to carry the observation carrier 100, and by an stop portion 56b1 against the side surface S of the observation carrier 100 to prevent generating an unexpected rotation of the observation carrier 100 relative to the positioning shaft 56c. The motor 56a is configured to drive the positioning shaft 56c, the bearing component 56b and the observation carrier 100 to rotate together, such that the plurality of observation positions of the arc-shaped observation flow channel C1 sequentially pass through the observation field of the microscopic observation module 54.

In an embodiment, the microscopic observation module 54 may include a light detector 54a and a microscope objective 54b. The microscope objective 54b is disposed between the arc-shaped observation flow channel C1 and the light detector 54a, such that the light detector 54a is capable of performing a microscopical observation on the at least one sample in the arc-shaped observation flow channel C1. In other embodiments, the microscopic observation module 54 can be in other suitable forms or their combinations, but the disclosure is not limited thereto. In addition, the driving unit 56 in the embodiment may further comprise a positioning plate 56d and a light sensor 56e, and the positioning plate 56d rotates in synchronization with the positioning shaft 56c. The positioning plate 56d comprises a through hole 56d1. When the through hole 56d1 is aligned with the light sensor 56e by the rotation of the positioning plate 56d, the signal light emitted by the light sensor 56e can be sensed through the through hole 56d1 to determine the rotating state of the motor 56a.

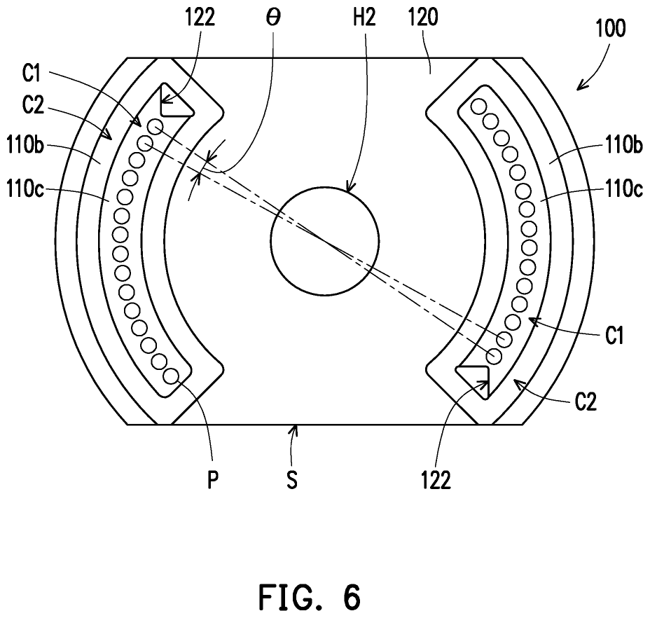

FIG. 6 illustrates a plurality of observation positions of the observation carrier shown in FIG. 1. In an embodiment, the motor 56a of the driving unit 56 is, for example, a step motor; in other embodiments, the driving unit 56 can drive the observation carrier 100 to rotate by other driving elements of suitable forms, which is not limited by the disclosure. Taking a step motor as an example, the step motor can drive the observation carrier 100 to rotate at a step angle θ as shown in FIG. 6, such that a plurality of observation positions P of the arc-shaped observation flow channel C1 of the observation carrier 100 sequentially pass through the observation field of the microscopic observation module 54. Assuming that the number of observation positions P of a single arc-shaped observation flow channel C1 is 15 as shown in FIG. 6, the microscopic image size of the light sensor 54a is, for example, 1.4×1.0 mm², the depth d1 of the arc-shaped observation flow channel C1 is, for example, 0.1 mm, the dilution factor of the cell fluid is, for example, X. If the total number of cells observed by the light detector 54a in the 15 observation positions P is N, then the cell number per unit volume (mm³) is estimated approximately to be (N×X)/(15×1.4×1.0×0.1), that is, N×X×0.47619.

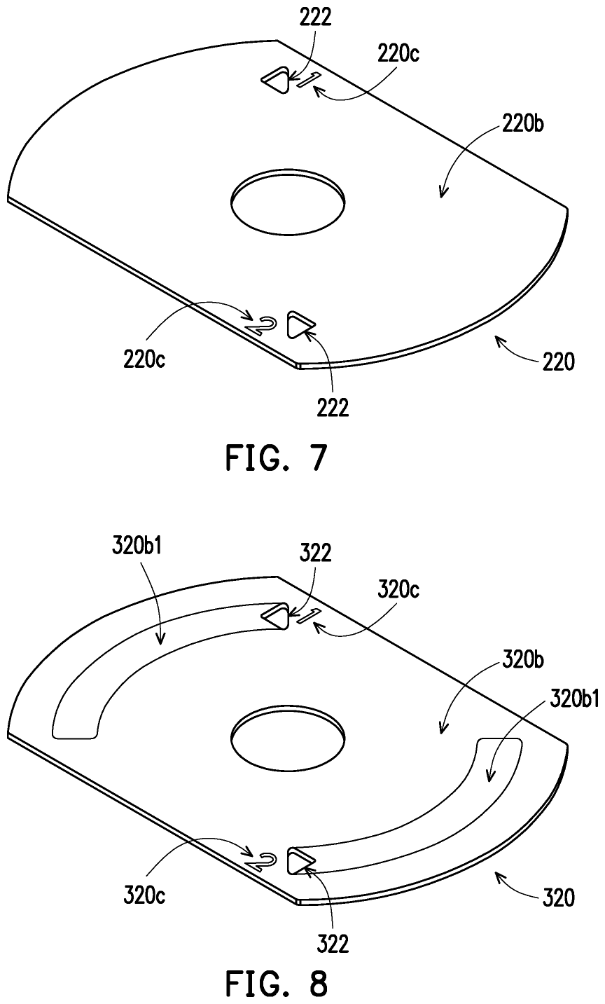

FIG. 7 is a perspective view of the second substrate according to another embodiment of the present disclosure. The second substrate 220 shown in FIG. 7 is different from the second substrate 120 described above in that, a mark 220c for identifying two inlets 222 on an upper surface 220b of the second substrate 220, indicates the two inlets 222 are frosted and atomized, grooved or bumped to be easily identified, and the rest of the upper surface 220b is transparent.

FIG. 8 is a perspective view of the second substrate according to another embodiment of the present disclosure. A second substrate 320 shown in FIG. 8 is different from the second substrate 120 described above in that, an arc-shaped observation area 320b1 and a mark 320c for identifying two inlets 322 on an upper surface 320b of the second substrate 320 are transparent, and the rest of the upper surface 320b is frosted and atomized for easy identification.

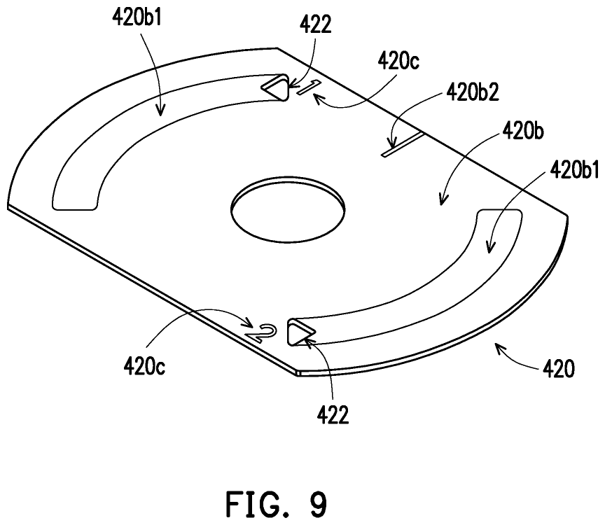

FIG. 9 is a perspective view of the second substrate according to another embodiment of the present disclosure. A second substrate 420 shown in FIG. 9 is different from the second substrate 120 described above in that, an arc-shaped observation area 420b1 and a mark 420c for identifying inlets 422 on an upper surface 420b of the second substrate 420 are transparent, and the rest of the upper surface 420b is frosted and atomized for easy identification. In addition, a positioning mark 420b2 of the upper surface 420b is transparent. When the positioning mark 420b2 is located at the light sensor, the signal light emitted by the light sensor can be sensed through the positioning mark 420b2, thereby determining the rotation state of the motor. That is, the through hole 56d1 of the positioning plate 56d in the above embodiment can be replaced by the positioning mark 420b2 of the upper surface 420b for the light sensor to sense.

In summary, in the observation carrier of the present disclosure, since the observation flow channel is designed to be arc-shaped, the observation device may drive the observation carrier to rotate and let the plurality of observation positions of the observation flow channel sequentially pass through the observation field of the microscopic observation module, which may effectively increase the observation range to improve the counting accuracy of the observations (such as cells). Moreover, since the observation device 50 only needs to drive the observation carrier 100 to rotate to achieve the effect of increasing the observation range as described above, it is only necessary to configure one single driving unit 56 to drive the observation carrier 100 to rotate without using the X-Y axis mobile platform to drive the observation carrier 100, thereby saving the equipment costs. Furthermore, since the arc-shaped observation flow channel and the air drainage outlet are separated by the air drainage channel, it is effective to prevent the at least one sample to be observed from being unexpectedly moved from the arc-shaped observation flow channel to the air drainage outlet due to the capillary phenomenon and cannot be observed successfully.

It will be apparent to those skilled in the art that various modifications and variations can be made to the structure of the disclosed embodiments. It is intended that the specification and examples be considered as exemplars only, with a true scope of the disclosure being indicated by the following claims and their equivalents.

What is claimed is:

1. An observation carrier adapted to observe at least one sample, the observation carrier comprising:
a first substrate; and
a second substrate, stacked on the first substrate, wherein at least one arc-shaped observation flow channel, at least one air drainage channel, and at least one air drainage outlet are formed between the first substrate and the second substrate, and the at least one arc-shaped observation flow channel and the at least one air drainage outlet are separated by the at least one air drainage channel.

2. The observation carrier according to claim 1, wherein the at least one arc-shaped observation flow channel is surrounded by the at least one air drainage channel.

3. The observation carrier according to claim 1, wherein the first substrate comprises a first overlapping surface, the second substrate comprises a second overlapping surface, the first overlapping surface and the second overlapping surface face each other, and the at least one arc-shaped observation flow channel and the at least one air drainage channel are formed between the first overlapping surface and the second overlapping surface.

4. The observation carrier according to claim 3, wherein a depth of the at least one arc-shaped observation flow channel is less than a depth of the at least air drainage channel in a direction perpendicular to the first overlapping surface and the second overlapping surface.

5. The observation carrier according to claim 3, wherein a side surface of the observation carrier is located at an edge of the first overlapping surface and the second overlapping surface, the at least one air drainage outlet is formed on the side surface.

6. The observation carrier according to claim 5, wherein the at least one air drainage channel extends to the side surface to form the at least one air drainage outlet.

7. The observation carrier according to claim 1, wherein the first substrate comprises at least one groove and at least one arc-shaped platform surrounded by the at least one groove, the at least one arc-shaped observation flow channel is formed between the second substrate and the at least one arc-shaped platform, and the at least one air drainage channel is formed between the second substrate and the at least one groove.

8. The observation carrier according to claim 1, wherein the second substrate comprises at least one inlet, and the at least one inlet is connected with the at least one arc-shaped observation flow channel.

9. The observation carrier according to claim 1, wherein the first substrate and the second substrate are transparent substrates.

10. The observation carrier according to claim 1, wherein at least one of the first substrate and the second substrate comprises a shaft hole, and the shaft hole is located at a curvature center of the at least one arc-shaped observation flow channel.

11. An observation device adapted to observe at least one sample, the observation device comprising:
an observation carrier, comprising:
a first substrate; and
a second substrate, stacked on the first substrate, wherein at least one arc-shaped observation flow channel, at least one air drainage channel, and at least one air drainage outlet are formed between the first substrate and the second substrate, and the at least one arc-shaped observation flow channel and the at least one air drainage outlet are separated by the at least one air drainage channel;
a light source, disposed on one side of the observation carrier and adapted to provide a light beam to the observation carrier;
a microscopic observation module, disposed on the other side of the observation carrier and adapted to observe an image of the at least one sample in the at least one arc-shaped observation flow channel by the light beam; and
a driving unit, adapted to drive the observation carrier to rotate, such that a plurality of observation positions of the at least one arc-shaped observation flow channel sequentially pass a transmission path of the light beam.

12. The observation device according to claim 11, wherein the at least one arc-shaped observation flow channel is surrounded by the at least one air drainage channel.

13. The observation device according to claim 11, wherein the first substrate comprises a first overlapping surface, the second substrate comprises a second overlapping surface, the first overlapping surface and the second overlapping surface face each other, and the at least one arc-shaped observation flow channel and the at least one air drainage channel are formed between the first overlapping surface and the second overlapping surface.

14. The observation device according to claim 13, wherein a depth of the at least one arc-shaped observation flow channel is less than a depth of the at least air drainage channel in a direction perpendicular to the first overlapping surface and the second overlapping surface.

15. The observation device according to claim 13, wherein a side surface of the observation carrier is located at an edge of the first overlapping surface and the second overlapping surface, and the at least one air drainage outlet is formed on the side surface.

16. The observation device according to claim 15, wherein the at least one air drainage channel extends to the side surface to form the at least one air drainage outlet.

17. The observation device according to claim 11, wherein the first substrate comprises at least one groove and at least one arc-shaped platform surrounded by the at least one groove, the at least one arc-shaped observation flow channel is formed between the second substrate and the at least one arc-shaped platform, and the at least one air drainage channel is formed between the second substrate and the at least one groove.

18. The observation device according to claim 11, wherein the second substrate comprises at least one inlet, and the at least one inlet is connected with the at least one arc-shaped observation flow channel.

19. The observation device according to claim 11, wherein the first substrate and the second substrate are transparent substrates.

20. The observation device according to claim 11, wherein at least one of the first substrate and the second substrate comprises a shaft hole, and the shaft hole is located at a curvature center of the at least one arc-shaped observation flow channel.
